(19) United States
(12) Patent Application Publication
(10) Pub. No.: US 2026/0365259 A1
(43) Pub. Date: Nov. 19, 2026

(54) SECURING MECHANISM FOR A CAB EXTENDER

(71) Applicant: Transtex Inc., Saint-Laurent (CA)

(72) Inventors: Jeffrey Angst, Nashville, TN (US); Philippe Picchiottino, Saint-Laurent (CA); Sylvain Daoust, Saint-Laurent (CA); Mathieu Boivin, Saint-Laurent (CA); Logan BIRCHFIELD, Nashville, TN (US)

(21) Appl. No.: 19/630,931

(22) Filed: Mar. 27, 2026

Related U.S. Application Data
(60) Provisional application No. 63/781,913, filed on Apr. 1, 2025.

(51) Int. Cl. B62D 35/00; B62D 49/00

(52) U.S. Cl. CPC B62D 35/001; B62D 35/008; B62D 49/005

(57) ABSTRACT

Herein are described support assemblies for securing a cab extender to the cab of a tractor, wherein a series of support assemblies can be used to secure the cab extender. The support assemblies comprise a support designed to secure two sections of the cab extender thereto, one close to the cab and another distant from the cab, with one section free in-between. The support is adapted, when the cab extender sustains a jack-knife, to collapse and flex, preventing the cab and the cab extender from damage resulting from the external force.

### CROSS-REFERENCE

The present application relates to United States Provisional Patent Application number 63/781,913, filed Apr. 1, 2025, and United States Provisional Patent Application number 63/838,101, filed Jul. 3, 2025. Both documents are incorporated by reference in their entireties.

### BACKGROUND

### (a) Field

This invention generally relates to a support assembly for securing a cab extender at the rear of a cab of a tractor, reducing the drag of the cab or tractor. More precisely, the invention relates to a self-compliant part of a support assembly for securing a cab extender at the rear of a cab of a tractor.

### (b) Related Prior Art

Road tractors are used to pull semi-trailers on roads to transport cargo. Aerodynamic apparatuses are installed on the road tractor and/or on the semi-trailer in order to reduce the aerodynamic air drag and improve fuel efficiency.

Cab extenders are secured to the rear of the tractor, between the tractor and the trailer, in order to decrease the drag generated by the tractor and the trailer when they are moving. The cab extenders are made of stiff, yet deformable, resilient panel or panels made from low-cost materials.

Today, the cab extenders are secured using very stiff brackets, sometimes with each bracket being entirely different, which increases the cost of installing the cab extenders and complicates the installation process. Furthermore, the use of very stiff brackets results in the truck cab being damaged when a jack-knife of the tractor and trailer occurs.

FIG. 1 depicts an installation of a PRIOR ART cab extender to the cab 80 of a tractor according to available technology. FIG. 1 shows that the brackets 92 of the PRIOR ART may be different based on the positions they are used in, showing for instance longer brackets at the top and the bottom than in the middle section of the different cab extender 90.

Therefore, there exists a need in the art for improvement over the technique used to secure cab extenders to a cab of a tractor. There is a need in the art for an improved support assembly adapted to decrease costs, for improved ease of installation, and to mitigate or prevent damages upon occurrence of jack-knifes. There is also a need for a support that can flex and that can be adapted to be used regardless of the section of the cab extender attached thereto.

### SUMMARY

In some aspects, the techniques described herein relate to a support assembly comprising a support designed to be secured to the cab extender and a customizable securing assembly for securing the support to the cab in an adjustable fashion such that identical support assemblies may be used to secure different sections of the cab extenders.

In some aspects, the customizable securing assembly comprises a combination of a mounting bracket and a clamping bracket securable to one another, such as to ensure the incorporation of the support into the support assembly, with means to secure them together.

In some embodiments, the techniques described herein relate to cab extenders secured to the rear of a cab of a tractor using a plurality of support assemblies, each comprising a support.

In some aspects, the description herein relates to a support for securing a cab extender, with the support mounted to a cab of a tractor, the support including: a first section for mounting a fore section of the cab extender thereto about the cab, a second section for mounting an aft section of the cab extender rearward to the cab, and a strut section in-between the first section and the second section, wherein the support is adapted to mount the cab extender thereto with air generally flowing about the cab extender substantially from the fore section to the aft section of the cab extender when the tractor is moving forward.

In some aspects, the description herein relates to a support, wherein the support is adapted to collapse upon occurrence of a jack-knife, with the strut section thereof flexing, allowing the cab extender to be at least one of rotationally and translationally displaced.

In some aspects, the description herein relates to a support, wherein the cab includes a side wall extending to a rear wall, and wherein the support includes a mounting bracket adapted to be secured to the rear wall of the cab of the tractor and a support component for securing the cab extender thereto that is secured to the mounting bracket.

In some aspects, the description herein relates to a support, wherein the support includes further a clamping component adapted to be secured to the mounting bracket with the support component clamped between the mounting bracket and the clamping component.

In some aspects, the description herein relates to a support, wherein the support is adapted to collapse upon sustaining an external force over a threshold value directed towards a central longitudinal plane of the tractor.

In some aspects, the description herein relates to a support, wherein the strut section of the support is adapted to extend oblique to the cab extender.

In some aspects, the description herein relates to a support, wherein the strut section is adapted to extend at an angle of between 10 degrees and 40 degrees to the cab extender.

In some aspects, the description herein relates to a support, wherein distance between the cab extender and the support is greater about the first section than about the second section.

In some aspects, the description herein relates to a support, wherein the cab includes a side wall extending through a curved section into a rear wall, and wherein the support is adapted to be secured to the rear wall and to abut against the curved section of the cab.

In some aspects, the description herein relates to a support, wherein the cab includes a side wall extending to a rear wall, and wherein the cab extender secured to the support extends forward to the rear wall.

In some aspects, the description herein relates to a support, wherein the cab includes a side wall extending through a curved wall to a rear wall, and wherein the support includes a first wall adapted to be mounted to the rear wall of the cab, a second wall adapted to abut against the curved wall of the cab, and a wall section between the first wall and the second wall adapted to be contact-free to the cab when the support is mounted to the cab.

In some aspects, the description herein relates to a support, wherein the support is adapted to flex to a first distance when sustaining a first force directed toward a central longitudinal plane of the tractor and to a second distance that is less than the first distance when sustaining the first force directed away from the central longitudinal plane of the tractor.

In some aspects, the description herein relates to a tractor including a cab and a cab extender mounted thereto using at least one support, the tractor including: a side wall extending through a connection wall to a rear wall, a first one of the at least one support including a first section adapted to have secured thereto a fore section of the cab extender, a second section adapted to have an aft section of the cab extender secured thereto rearward to the rear wall of the cab, and a strut section in-between the first section and the second section contact-free to the cab extender, wherein the first support is adapted to extend substantially horizontal, with the cab extending frontward to the first section about the connection wall thereof.

In some aspects, the description herein relates to a tractor, wherein the first support is adapted to collapse upon occurrence of a jack-knife, with the strut section thereof flexing, thereby preventing or mitigating damage to the cab and to the cab extender.

In some aspects, the description herein relates to a tractor, wherein the first support is adapted to collapse upon sustaining an external force over a threshold value exerted towards a central longitudinal plane of the tractor.

In some aspects, the description herein relates to a tractor, wherein the first support includes a mounting section for securing to the rear wall of the cab.

In some aspects, the description herein relates to a tractor, wherein the strut section of the first support is adapted to extend oblique to the cab extender.

In some aspects, the description herein relates to a tractor, wherein the strut section is adapted to extend at an angle of between 10 degrees and 40 degrees to the cab extender.

In some aspects, the description herein relates to a tractor, wherein the first support is adapted to be secured to the rear wall and to abut against the connection wall of the cab.

In some aspects, the description herein relates to a compliant support for mounting a cab extender to a cab of a vehicle, the compliant support including a first section mounted to the cab of the vehicle and a second section to which is mounted the cab extender, wherein the cab extender is stiffly supported against bump, aerodynamic, and vibratory forces in service, and wherein the cab extender collapses elastically upon occurrence of a jack-knife.

Other embodiments and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, discloses preferred embodiments of the invention.

### BRIEF DESCRIPTION OF THE DRAWINGS

Referring now to the drawings, which form a part of this original disclosure:

FIG. 1 is a perspective rear view of a tractor with cab extenders secured thereto of the PRIOR ART;

FIG. 2 is a perspective view of a section of a cab extender with support assemblies secured thereto non-parallel to one another, ready to be secured to a cab (not depicted) in accordance with at least one embodiment of the invention;

FIG. 3 is a pictorial rear view of a tractor with a cab extender mounted thereto in accordance with an embodiment;

FIG. 4 is a cross-section side view of a tractor cut along a central longitudinal plane, with a cab extender mounted to the tractor in accordance with an embodiment;

FIG. 5 is a pictorial view of a section of a cab extender secured to a section of a cab using a support assembly in accordance with an embodiment;

FIG. 6 is a top view of a section of a cab extender secured to a section of a cab using a support assembly in accordance with an embodiment;

FIG. 7 is a perspective view of a support assembly in accordance with an embodiment;

FIG. 8 is a perspective exploded view of a support assembly in accordance with an embodiment;

FIG. 9 is a perspective bottom oblique view of an intermediate bracket with integrated bolts in accordance with an embodiment;

FIG. 10 is a perspective top oblique view of an intermediate bracket with no integrated bolts in accordance with an embodiment;

FIG. 11 is a side view of an intermediate bracket with integrated bolts in accordance with an embodiment;

FIG. 12 is a perspective view of a section of a cab with an intermediate bracket secured thereto in a first step of securing a cab extender to a cab of a tractor in accordance with an embodiment;

FIG. 13 is a perspective view depicting the step of securing a support and a mounting bracket to the clamping bracket at a second step of securing the cab extender to a cab of a tractor in accordance with an embodiment;

FIG. 14 is a perspective view depicting the step of securing the cab extender to the support at a third step of securing the cab extender to a cab of a tractor in accordance with an embodiment;

FIG. 15 is a perspective view of a section of a cab extender secured to a section of a cab using a support assembly in accordance with another embodiment; and

FIG. 16 is a top view of a section of a cab extender secured to a section of a cab using a support assembly in accordance with the embodiment of FIG. 15.

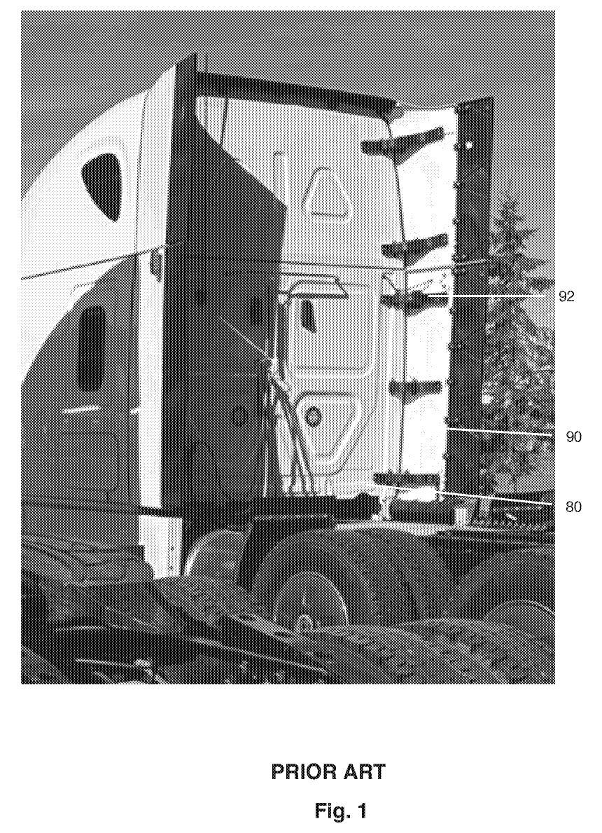

### DETAILED DESCRIPTION OF PREFERRED EMBODIMENTS

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term "or" should generally be understood to mean "and/or" and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as,” or the like) provided herein, is intended merely to better illuminate the exemplary realizations and does not pose a limitation on the scope of the realizations. No language in the specification should be construed as indicating any unclaimed element as essential to the practice of the realizations. The use of the term “substantially” is intended to mean “for the most part” or “essentially” depending on the context. It is to be construed as indicating that some deviation from the word it qualifies is acceptable as would be appreciated by one of ordinary skill in the art to operate satisfactorily for the intended purpose.

In the following description, it is understood that terms such as "first", "second,” "top,” "bottom,” "above,” "below,” and the like, are words of convenience and are not to be construed as limiting terms.

The terms "top,” “up,” “upper,” "bottom," “lower,” “down,” “vertical,” “horizontal,” “interior” and “exterior” and the like are intended to be construed in their normal meaning in relation to normal installation of the product.

It should further be noted that for purposes of this disclosure, the terms "coupled,” “mounted” and “secured” mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature.

An embodiment of the present invention is described below with reference to the drawings.

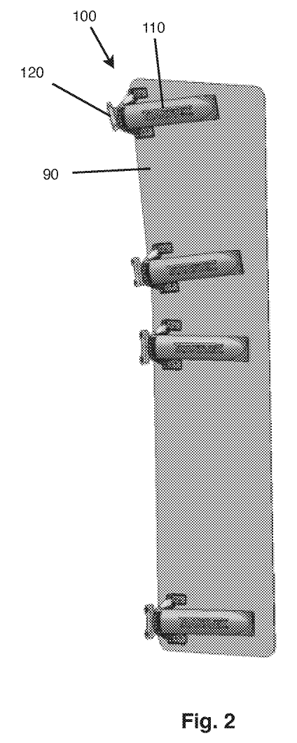

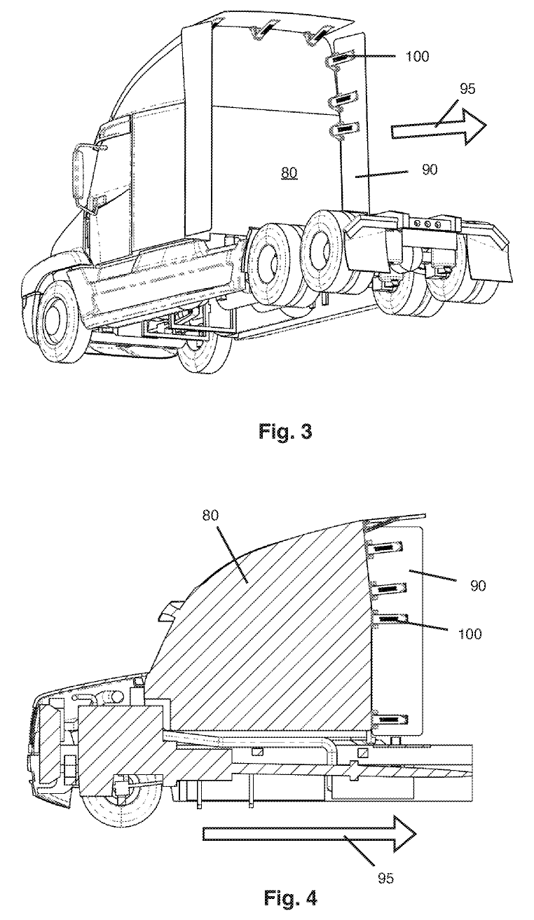

Referring to FIGS. 2-4, they illustrate a technique for securing a cab extender 90 to the rear wall 81 of a cab 80 of a tractor comprising a side wall 83 extending through a curved section 82 to the rear wall 81. The technique involves the use of multiple support assemblies 100 with preferably at least two of them being identical, but according to an embodiment being all identical to one another, wherein the support assemblies 100 are for securing the cab extenders 90 to the cab of the tractor. The support assemblies are further installed with their body extending substantially horizontal, e.g., within 15 degrees to the horizontal, and substantially parallel to each other, e.g., within 15 degrees relative to one another, and to the air flow 95, e.g., within 15 degrees relative thereto, extending rearward from the rear wall 81 of the cab 80.

According to a first embodiment, a support assembly 100 comprises a support 110 that is a deformable component that exhibits no permanent set or deformation after a large deflection resulting from an external force.

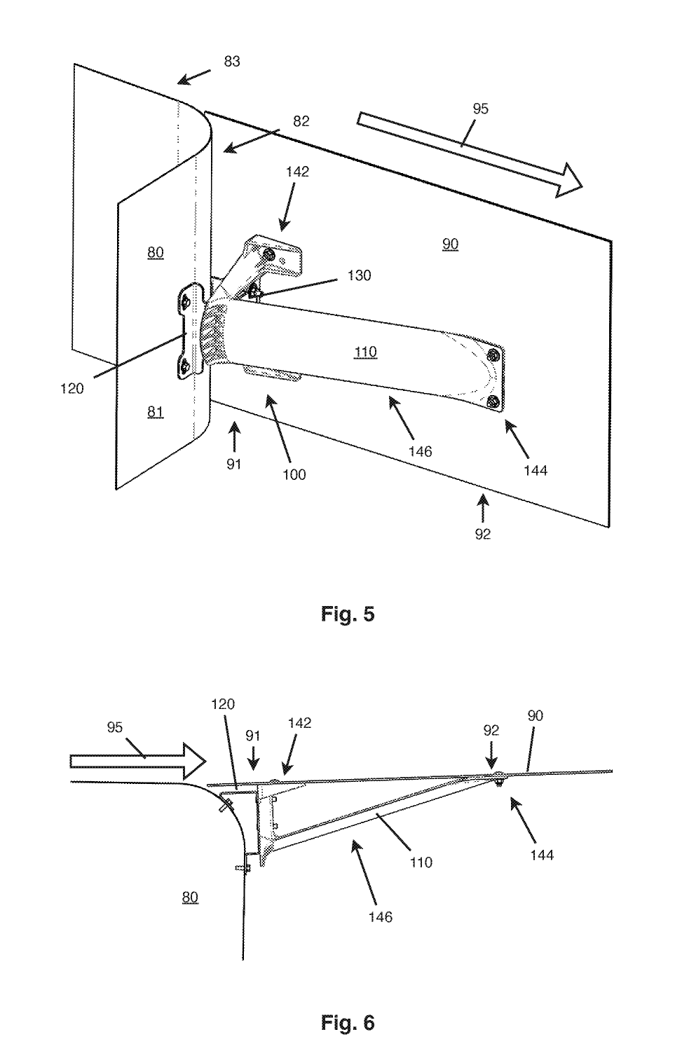

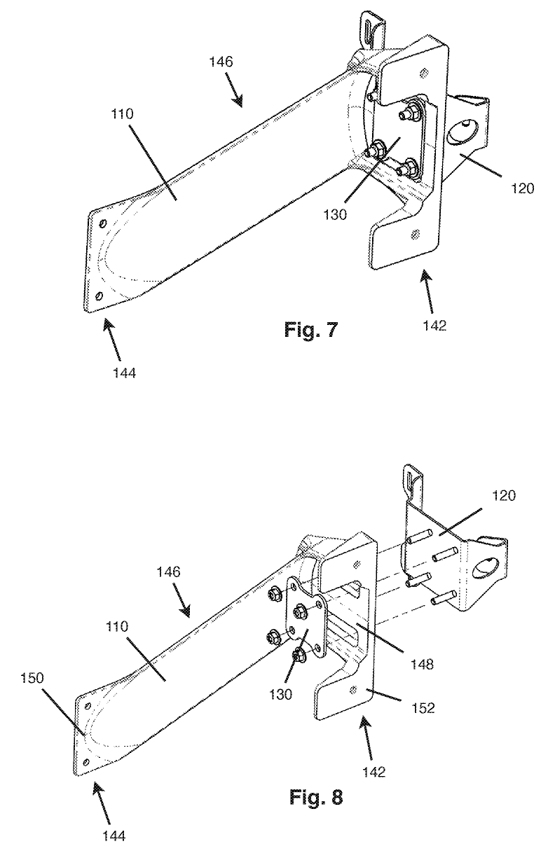

Referring additionally to FIGS. 5-8, the support 110 comprises a first section 142 providing a first wall to abut and to secure a fore section 91 of the cab extender 90 thereto close to the cab 80, a second section 144 providing another wall to abut and to secure an aft section 92 of the cab extender 90 thereto distant from the first section 142. The support 110 further comprises a strut section 146 in-between extending oblique relative to the cab extender 90 thus providing a contact-free section of the cab extender 90 between the fore section 91 and the aft section 92. The strut section 146 is adapted to deform upon undergoing an external force towards the central longitudinal plane of the cab 80, and restoring its original configuration and exhibiting no permanent deflection after the external force is released.

According to an embodiment, the strut section 146 is a strut section providing a contact-free section between a fore mounting section (first section 142) and an aft mounting section (second section 144). The strut section is configured to extend at an angle of, e.g., between 10 and 40 degrees to the cab extender 90, and preferably between 15 and 30 degrees to the cab extender, and more preferably about 20 degrees about the center thereof to the exterior face of the cab extender 90 and preferably also to the side wall 83 of the cab 80.

According to an embodiment, the first section 142, the second section 144, and strut section 146 are not aligned, generally configured in a L shape for the strut section 146, with the second section 144 distant from the first section 142.

According to an embodiment, the strut section 146 provides a strut member hereinbefore, with a flex section thereof, allowing the securing of two sections of the cab extender 90 at a distance to one another. In the illustrated embodiment, a planar section 150 of the second section 144 includes holes therein for securing the distant section of the cab extender 90 with fasteners or rivets, for example. The first section 142 comprises a planar section 152 comprising holes for mounting the cab extender 90 thereto close to the cab 80. Both planar sections 150, 152 are preferably aligned along a unique plane for efficiently securing and supporting the cab extender 90.

The support 110 comprises a base section 148 about the first section 142 that is designed to be clamped.

According to an embodiment, the shape of the strut member includes a concave section (when seen from, e.g., the base section 148). The concave section of the support offers some advantages in the manner the strength of the support is applied to the cab extender 90 when an external force, that might be caused by a jack-knife, is applied to the support 110. The side of the cavity of the concave section has an impact on the force required to collapse and bend the strut member. It can be appreciated that the cavity of the concave section toward the cab extender 90 provides more strength when a force is applied toward the central longitudinal plane of the cab 80. In case another behavior requiring a smaller force to bend the strut member is desirable, the concave section could alternatively be inverted, or an inverted concave section could be added without departing from the scope of the present description. The concave section, according to an embodiment, changes progressively and the section of the concave section tends to straighten. The resistance of the strut member is strong until the strut member collapses, after which it flexes easily. This offers significant advantages by strongly maintaining the cab extender 90 in an aerodynamically operating configuration that could flex and provide some deflection until a predetermined load is applied, e.g., jack-knife, that overcomes the buckling load threshold of the strut member design; the configured resistance to external forces being configured to avoid damage to the cab 80 of the tractor. In other words, the strut member is going to be strong and maintain an efficient operating configuration despite the loads applied thereon when the loads are smaller than the buckling load threshold and will become less resistant when buckling and more prone to flex and deflect significantly when the load applied thereon is beyond the buckling load threshold. The operating configuration position of the strut member, by its natural tendency to uncollapse, is automatically recovered when the load is significantly reduced or removed.

Accordingly, through the deformable buckling capability of the support, the support is adapted to provide limited deformation to the cab extender 90, with the deformation upon sustaining the same force toward the central longitudinal plane versus away from the central plane being of a greater degree toward the central longitudinal plane than away from the central longitudinal plane of the tractor.

When buckling, the securing nature of the cab extender 90 allows a cab extender 90 to flex according to a large radius of curvature, minimizing risks of damage to the cab extender 90.

To achieve the discussed characteristics, the support 110 is preferably made from a unitary body. The support 110 can be built from a variety of polymers that are flexible and resilient enough to perform the required flexion. Materials such as, but not limited to, polypropylene, nylon, nylon co-polymer, thermoplastic polyolefin, polyethylene, polycarbonate, and thermosets, charged with fibers or not, could be used. Alternatively, other materials such as metal that are designed to remain in their elastic domain can also be suitable to bend, collapse, and automatically recover their original shape. Manufacturing processes including, but not limited to, injection molding, machining, thermoforming, and RTM could be used in consideration of the selected material and other constraints.

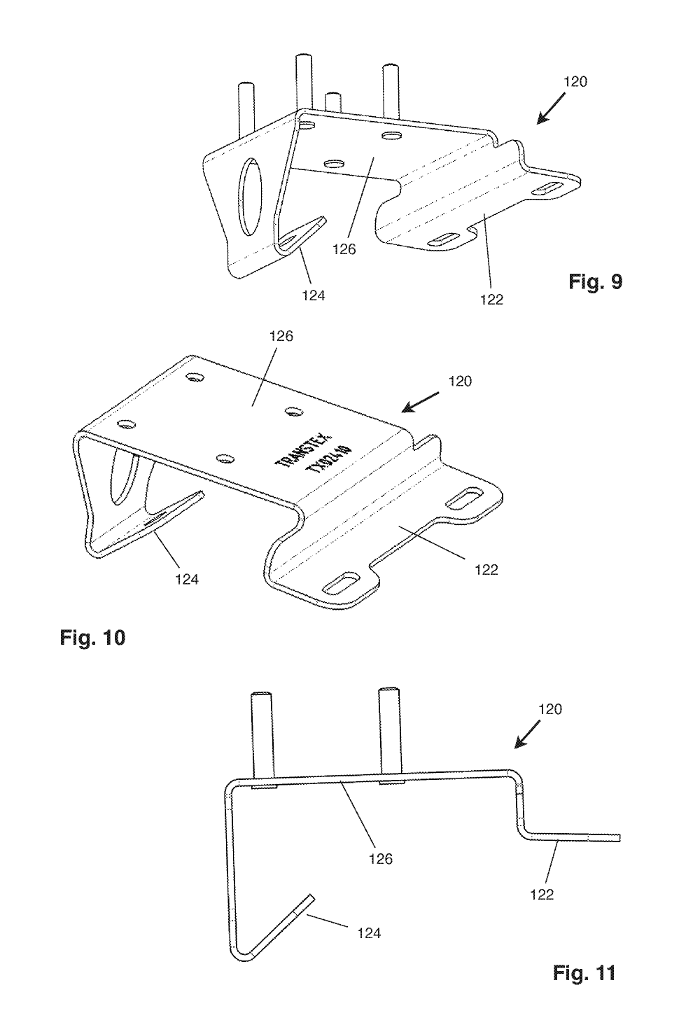

Referring additionally to FIGS. 9-11, the support assembly 100 further comprises a clamping bracket 120 to secure the support 110 thereto and to be secured to the cab 80. The clamping bracket 120 comprises a first member 122 to be secured to the cab, a second member 124 to be secured to the cab, and a body section 126 coupled to the first member 122 and the second member 124, for securing the support 110 thereto.

According to an embodiment, the clamping bracket 120 is made of a single piece of sheet metal, with the first member 122 and the second member 124 ending with securing holes for securing them to the cab using bolts or screws.

According to an embodiment, by deforming the first member 122 and the second member 124, the position and orientation of the support 110 may be customized for securing the cab extender at the desired position with the desired orientation.

The support assembly 100 further comprises a mounting bracket 130 for securing the body section 126 of the clamping bracket 120 using bolts and nuts, rivets, or other means of securing, such that the support 110 becomes clamped in-between the clamping bracket 120 and the mounting bracket 130.

The support assembly 100 is preferably secured to the cab 80 of the tractor to have the exterior of the cab extender 90 aligned, flush with the side wall of the tractor. The cab extender 90 is hence used as a vertical rearward wall that forms a continuity of the side wall of the tractor.

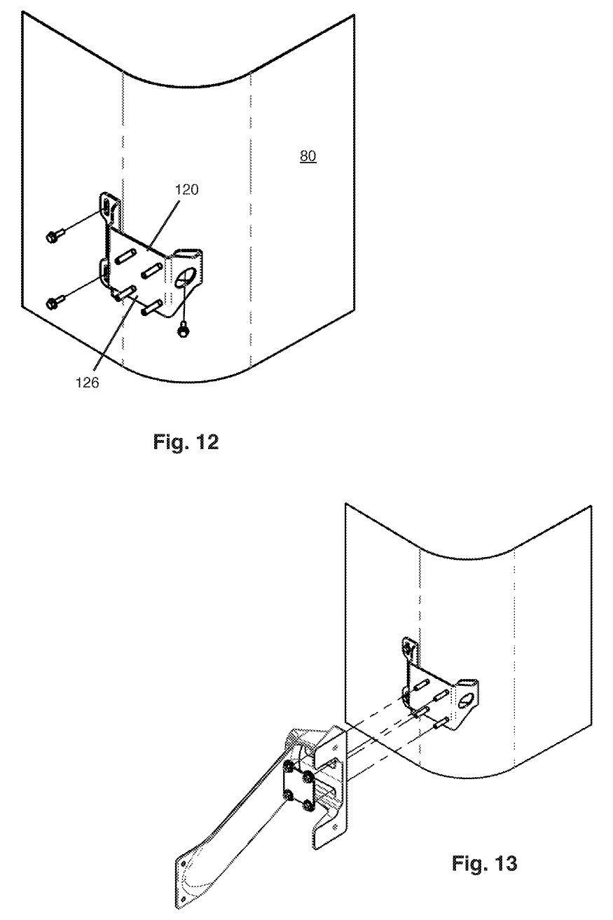

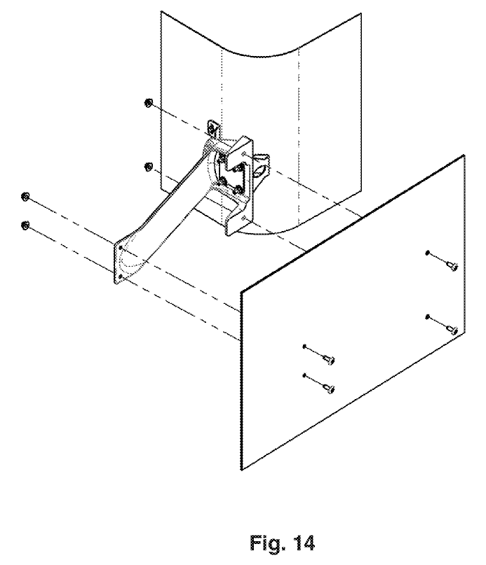

Referring to FIGS. 12-14, illustrating the general steps executed when securing the cab extender to the cab of a tractor. FIG. 12 depicts a perspective view of a section of a cab with an intermediate bracket secured thereto in a first step of securing a cab extender to a cab of a tractor. FIG. 13 depicts a perspective view depicting the step of securing a support and a mounting bracket to the clamping bracket at a second step of securing the cab extender to a cab of a tractor. FIG. 14 depicts a perspective view depicting the step of securing the cab extender to the support at a third step of securing the cab extender to a cab of a tractor in accordance with an embodiment.

According to an embodiment (not depicted), the securing assembly can be made of a clipping bracket adapted to grip the strut side of the base section of the support 110, to extend onto the fairing side of the base section of the support 110, and to hook onto. Therefore, the base section of the support becomes fixedly clamped into opposed sections of the clipping bracket. When securing the cab extender 90 to the support 110 with, e.g., rivets, the section of the clipping bracket extending between the support and the cab extender becomes clamped between the support 110 and the cab extender 90, ensuring that the support assembly remains assembled with the support 110 fixedly secured to the clipping bracket, itself secured to the cab of the tractor.

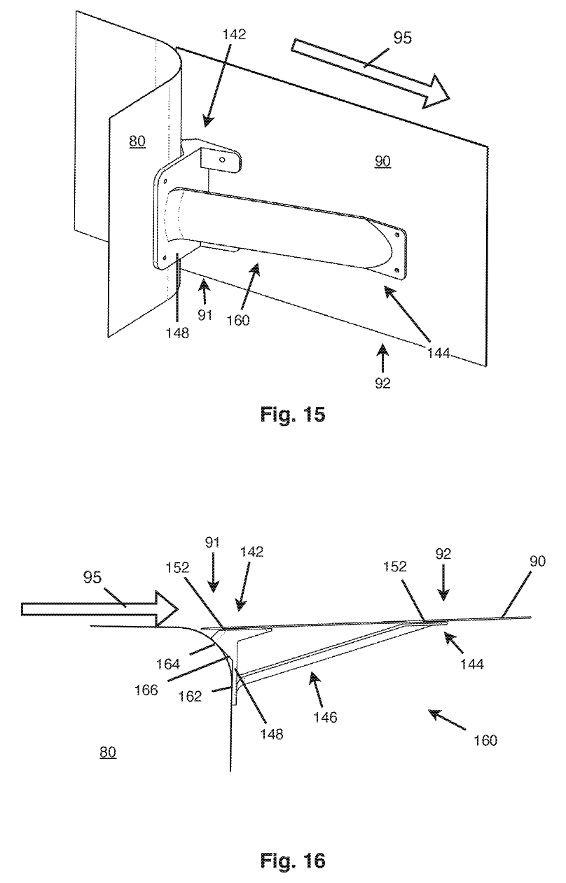

According to another embodiment, depicted in FIGS. 15-16 a support 160 is adapted to be installed without the use of a clamping bracket. The support 160 comprises, like the support 110, a first section 142 having a planar section 152 with holes for mounting the cab extender 90, a second section 144 having a planar section 150 with holes for mounting the cab extender 90 at a second position distant to the cab 80, a strut section 146 being a strut that can collapse. The support 160 features one or more walls 162, 164 adapted to be secured to or abut against the cab 80, preferably a first wall 162 to be secured to the rear wall 81 of the cab 80 and a second wall 164 to abut against the curved section 82, and a contact-free wall section 166 adapted to remain distant to the wall of the cab, allowing adjustment of the position of the cab support and thus adjustment of the cab extender 90 about flush to the side wall of the cab 80, its fore edge frontward to the rear wall 81 of the cab 80.

It is to be noted that the section of the cab extender 90 free of constraints between the planar sections 150, 152 allows some flexion to the cab extender 90 towards the central longitudinal plane of the cab 80 in that section when needed. The buckling capability of the strut section 146 combined with the section of the cab extender 90 free of constraints identified before further allows the cab extender 90 to flex such that the rear edge of the cab extender 90 moves towards the central longitudinal plane of the cab 80 without the cab extender 90 or the supports 110, 160 sustaining damage. The supports 110, 160, through such characteristics, provide a great solution to hold a cab extender 90, mounting the cab extender 90 in a relatively rigid fashion, while allowing minimal deformations of the cab extender 90 without having the supports 110, 160 collapse, and having under a greater force the supports 110, 160 to collapse and the cab extender 90 to flex inwards without any part sustaining damage, including the cab extender 90.

Furthermore, the characteristics of the strut section 146 allow substantial resistance to vertical forces. The use of multiple supports 110, 160 to secure a single planar cab extender 90 limits the twisting response that the strut section 146 would have alone. And the wide abutting surface of the support 110, 160 at the junction of the strut section 146 and the base section 148 provides improved vertical stability to the supports 110, 160.

According to an embodiment, the cab extender 90 and one of the planar sections 152 are slidingly secured to one another, allowing the cab extender to move in a longitudinal direction relative to the strut section 146 when curving. In an embodiment, that slidable mode of securing fixes the height of the cab extender 90 and while allowing small horizontal displacement relative to one another.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

1. A support for securing a cab extender, with the support mounted to a cab of a tractor, the support comprising:
a first section for mounting a fore section of the cab extender thereto about the cab, a second section for mounting an aft section of the cab extender rearward to the cab, and a strut section in-between the first section and the second section,
wherein the support is adapted to mount the cab extender thereto with air generally flowing about the cab extender substantially from the fore section to the aft section of the cab extender when the tractor is moving forward.

2. The support of claim 1, wherein the support is adapted to collapse upon occurrence of a jack-knife, with the strut section thereof flexing, allowing the cab extender to be at least one of rotationally and translationally displaced.

3. The support of claim 1, wherein the cab comprises a side wall extending to a rear wall, and wherein the support comprises a mounting bracket adapted to be secured to the rear wall of the cab of the tractor and a support component for securing the cab extender thereto that is secured to the mounting bracket.

4. The support of claim 3, wherein the support comprises further a clamping component adapted to be secured to the mounting bracket with the support component clamped between the mounting bracket and the clamping component.

5. The support of claim 1, wherein the support is adapted to collapse upon sustaining an external force over a threshold value directed towards a central longitudinal plane of the tractor.

6. The support of claim 1, wherein the strut section of the support is adapted to extend oblique to the cab extender.

7. The support of claim 6, wherein the strut section is adapted to extend at an angle of between 10 degrees and 40 degrees to the cab extender.

8. The support of claim 6, wherein distance between the cab extender and the support is greater about the first section than about the second section.

9. The support of claim 1, wherein the cab comprises a side wall extending through a curved section into a rear wall, and wherein the support is adapted to be secured to the rear wall and to abut against the curved section of the cab.

10. The support of claim 1, wherein the cab comprises a side wall extending to a rear wall, and wherein the cab extender secured to the support extends forward to the rear wall.

11. The support of claim 1, wherein the cab comprises a side wall extending through a curved wall to a rear wall, and wherein the support comprises a first wall adapted to be mounted to the rear wall of the cab, a second wall adapted to abut against the curved wall of the cab, and a wall section between the first wall and the second wall adapted to be contact-free to the cab when the support is mounted to the cab.

12. The support of claim 1, wherein the support is adapted to flex to a first distance when sustaining a first force directed toward a central longitudinal plane of the tractor and to a second distance that is less than the first distance when sustaining the first force directed away from the central longitudinal plane of the tractor.

13. A tractor comprising a cab and a cab extender mounted thereto using at least one support, the tractor comprising:
a side wall extending through a connection wall to a rear wall,
a first one of the at least one support comprising a first section adapted to have secured thereto a fore section of the cab extender, a second section adapted to have an aft section of the cab extender secured thereto rearward to the rear wall of the cab, and a strut section in-between the first section and the second section contact-free to the cab extender,
wherein the first support is adapted to extend substantially horizontal, with the cab extending frontward to the first section about the connection wall thereof.

14. The tractor of claim 13, wherein the first support is adapted to collapse upon occurrence of a jack-knife, with the strut section thereof flexing, thereby preventing or mitigating damage to the cab and to the cab extender.

15. The tractor of claim 13, wherein the first support is adapted to collapse upon sustaining an external force over a threshold value exerted towards a central longitudinal plane of the tractor.

16. The tractor of claim 13, wherein the first support comprises a mounting section for securing to the rear wall of the cab.

17. The tractor of claim 13, wherein the strut section of the first support is adapted to extend oblique to the cab extender.

18. The tractor of claim 13, wherein the strut section is adapted to extend at an angle of between 10 degrees and 40 degrees to the cab extender.

19. The tractor of claim 13, wherein the first support is adapted to be secured to the rear wall and to abut against the connection wall of the cab.

20. A compliant support for mounting a cab extender to a cab of a vehicle, the compliant support comprising a first section mounted to the cab of the vehicle and a second section to which is mounted the cab extender,
wherein the cab extender is stiffly supported against bump, aerodynamic, and vibratory forces in service, and wherein the cab extender collapses elastically upon occurrence of a jack-knife.
